(19) United States
(12) Patent Application Publication
(10) Pub. No.: US 2010/0138361 A1
(43) Pub. Date: Jun. 3, 2010

(54) SYSTEM AND METHOD OF SECURITY PRICING FOR PORTFOLIO MANAGEMENT SYSTEM

(75) Inventors: Bradley Greer, Bartlett, TN (US); David C. Seahorn, Germantown, TN (US); Ward Wilcox, Anacortes, WA (US)

Correspondence Address: STEPTOE & JOHNSON LLP, 1330 CONNECTICUT AVENUE, N.W., WASHINGTON, DC, 20036, US

(73) Assignee: MK Asset, Inc., Wilmington, DE (US)

(21) Appl. No.: 12/603,571

(22) Filed: Oct. 21, 2009

Related U.S. Application Data
(60) Provisional application No. 61/107,549, filed on Oct. 22, 2008.

(51) Int. Cl. G06Q 40/00

(52) U.S. Cl. 705/36 R; 705/35

(57) ABSTRACT

A portfolio pricing system and method can include a database receiving multiple feeds, an analytics server in communication with the database, and an accounting server. The analytics server can include a pricing algorithm that assigns prices to the analytics server and the accounting server according to a hierarchy that selects the most reliable source for each type of security. The reliability may be determined within a date range or according to the source of the price.

### CLAIM OF PRIORITY

This application claims priority to provisional U.S. application No. 61/107,549, filed Oct. 22, 2008, which is hereby incorporated by reference.

### TECHNICAL FIELD

The invention relates to a bond and portfolio analytics system and method used in the financial services industry.

### BACKGROUND

New investment products and instruments are being brought to market, creating new challenges and opportunities to increase return. This requires accessing and analyzing vast amounts of account information and market data.

### SUMMARY OF THE INVENTION

In general, a portfolio pricing system and method can include a database receiving multiple feeds, an analytics server in communication with the database, and an accounting server. The analytics server can include a pricing algorithm that assigns prices to the analytics server and the accounting server according to a hierarchy that selects the most reliable source for each type of security. The reliability may be determined within a date range or according to the source of the price.

The analytics server may receive price information from a first set of feeds. The accounting server may receive price information from a second set of feeds. The first set and second set of feeds may be identical, or different.

The portfolio pricing system may further include a web server in communication with the analytics server that provides website to a user. The website can be used by a user to request a report. The report may be interactive and sortable. The report may be customized or pre-formatted. The report may be presented in a spreadsheet format. The report may be in real-time. The report may be encrypted.

The analytics server may be configured for portfolio attribution and measurement. The analytics server may be configured for risk management. The analytics server may be configured for quantitative analysis. The analytics server may be configured for detailed analytics. The detailed analytics may include cashflows for a total portfolio, for a sector of a total portfolio, or for individual bonds. The analytics server may be configured for trade simulation. The analytics server may be configured for a monthly rate of return on a portfolio, a daily rate of return, or a time-weighted rate of return.

The portfolio pricing method may include creating a hierarchy for a price of a security in an analytics system based upon reliability, creating a hierarchy for a price of a security in an accounting system based upon reliability, and selecting a most reliable price between the price in the analytics system and the price in the accounting system. The portfolio pricing method may further include assigning the price of the security in the analytics system and the price of the security in the accounting system to be the selected price, preventing two different prices from being published with the same pricing date. The portfolio pricing method may further include displaying the selected price to a user upon request. The portfolio pricing method may further include generating an interactive report from the analytics system for a user upon request. The reliability may be determined within a date range, or according to the source of the price.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is an exemplary website of a client relationship management system.

FIG. 2 exemplarily illustrates a graphical user interface for preparing a financial portfolio.

FIG. 3 exemplarily illustrates a graphical user interface for preparing a custom report.

FIG. 4 illustrates portfolio research capabilities.

FIG. 5 illustrates portfolio research capabilities.

FIG. 6 illustrates portfolio research capabilities.

FIG. 7 illustrates portfolio research capabilities.

FIGS. 8A and 8B illustrate portfolio research capabilities.

FIG. 9 is a block diagram of a client relationship management system.

FIG. 10 exemplarily illustrates a financial information report.

### DETAILED DESCRIPTION

Although the following detailed description contains many specific details for the purposes of illustration, anyone of ordinary skill in the art will appreciate that many variations and alterations to the following details can be incorporated in the system and methods described herein. Accordingly, the exemplary embodiments described below are set forth without any loss of generality to, and without imposing limitations upon, any claimed invention.

Financial analytics are widely used in research in the equity and corporate bond markets. Financial analytics form a key role in fundamental analysis. Fundamental analysis methods focus on what should happen to stock or corporate bond prices by examining why they move. Fundamental analysis looks at the economic, political and environmental factors that could affect a company's or an industry's performance; the analysis also uses financial information and a range of financial analytics to review past performance or gauge future prospects.

Company fundamental data is a principal research resource and serves as one basis for financial analytics. Investment managers and analysts look for services that provide company annual and interim results over several years in order to track performance. Investors rely on quick access to key sections of companies' accounts and to the financial measures commonly used in analytics. These range from multiple profit measures and revenue and cash flow figures to pre-calculated ratios, such as earnings or dividend per share.

While portfolio managers and analysts use analytics based on historical information for a view of past performance, they also need access to analytics that project future performance. As a result, investors use services that additionally provide forecast information ranging from detailed brokers' estimates to company guidance on future financial results.

For financial analytics to be meaningful, the analytics need to draw on consistent information across all companies and over time. Investors use services that offer accurate and timely data, presented in a standardized format, and that adopt uniform analytics methodologies.

Investors also use purpose-built analytics tools and functionality that enables them to find and filter information quickly, search by multiple criteria, and chart and download data to perform their own analytics.

A bond and portfolio analytics program provides information and analytics for equity and corporate bond market professionals. The portfolio analytics program offers detailed financial data on many listed companies around the world, including company fundamentals, estimates and research, and a wide range of financial analytics. Financial data is checked for accuracy and consistency.

Generally, the portfolio analytics program includes a database that is updated from feeds received from various financial and news sources, including, e.g., Bloomberg, Thomson, Reuters, etc. The database performs 80 or more processes per day to update securities information including, e.g., call dates, if called, etc. The information may be received via FTP, for example.

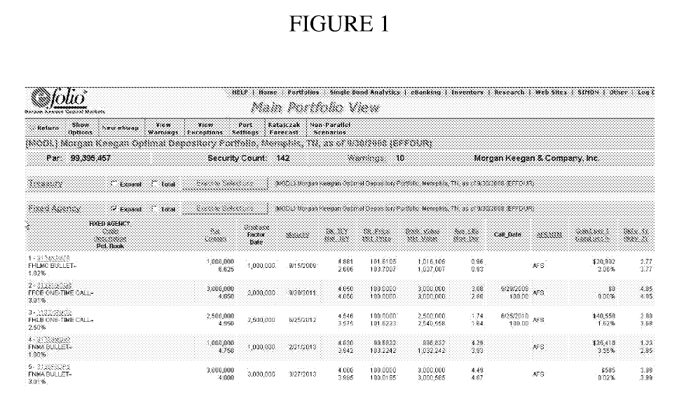

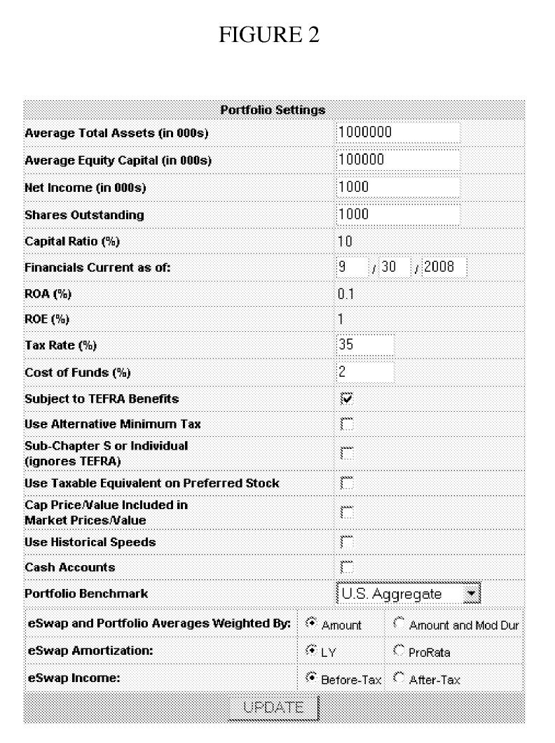

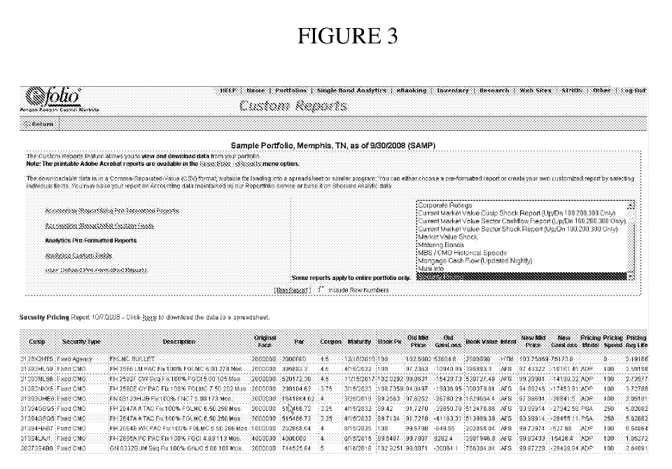

A user accesses the data stored on the database using a website. FIG. 1 shows an exemplary website. The website of FIG. 1 is handled through ordinary secure web servers, and may be controlled using XML, for example. The website of FIG. 1 is an initial overview of a portfolio view and includes links to portfolios. Portfolio information can be inputted and edited, as shown in FIG. 2. Additionally, FIG. 2 shows calculation method options that can be changed by the user and viewed immediately. On demand, the website of FIG. 1 communicates with the database and receives encrypted real-time data to the user. The live report may include adjustable filters, columns, etc., as shown exemplarily in FIG. 3, e.g., a menu of custom analytical reports is shown with a pricing report selected. The information may be presented in a spreadsheet or grid format that allows for customized or pre-formatted reports and graphs. The information may be received via FTP, for example.

The portfolio analytics program holds information about securities, portfolios, and users, including access information. The portfolio analytics program may include applications for portfolio attribution and measurement, risk management, and quantitative analysis. The portfolio analytics program may provide detailed analytics, including cashflows, on the total portfolio, sectors, and individual bonds. The portfolio analytics program provides immediate results and online interaction.

The portfolio analytics program may integrate analytics, cashflows, market value shocks, accounting and trade simulation. Portfolio data, including market value shocks and cashflows, may be grouped in total, by sector, or viewed individually. The portfolio analytics program may provide a single platform for portfolio management, offerings, research and other web resources.

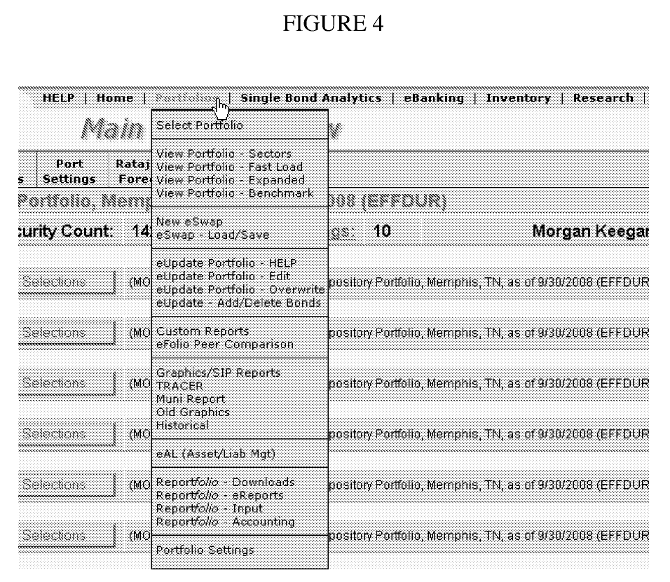

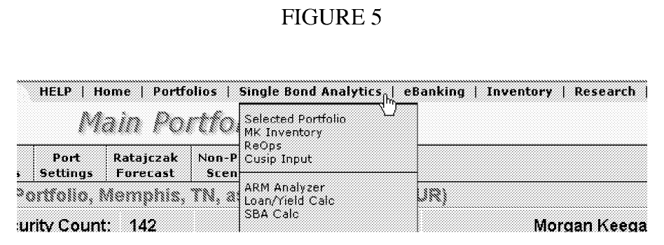

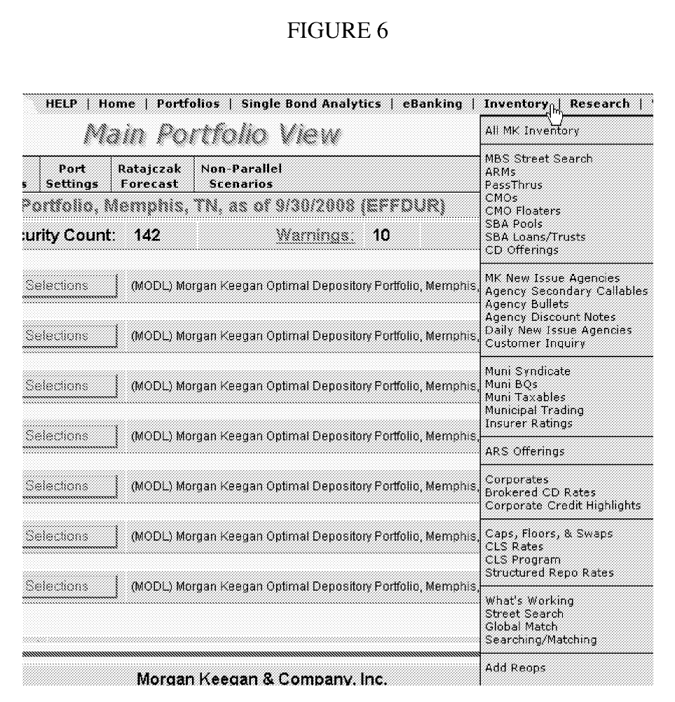

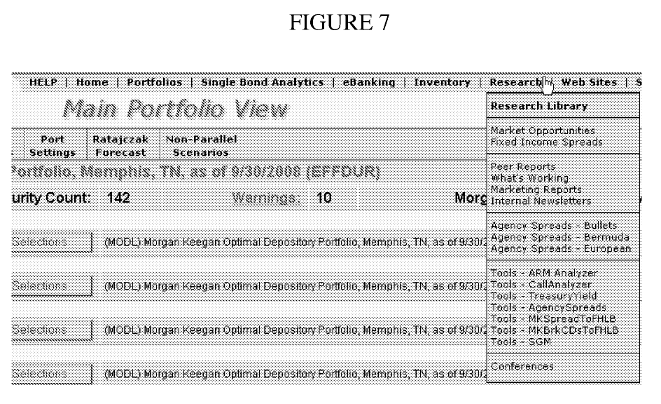

The portfolio analytics program may provide for portfolio management, as in FIG. 4, which shows a menu of different portfolio views. The portfolio analytics program may provide for bond analytics, including yield analysis, as in FIG. 5, which shows a menu of options for doing custom detailed analytics on a selected bond. The portfolio analytics program may provide for a view of available offerings, as in FIG. 6, which shows a menu of inventory types available for replacing maturities and executing portfolio strategies. The portfolio analytics program may provide for portfolio research, as in FIG. 7, which shows a menu of recent research and access to research library.

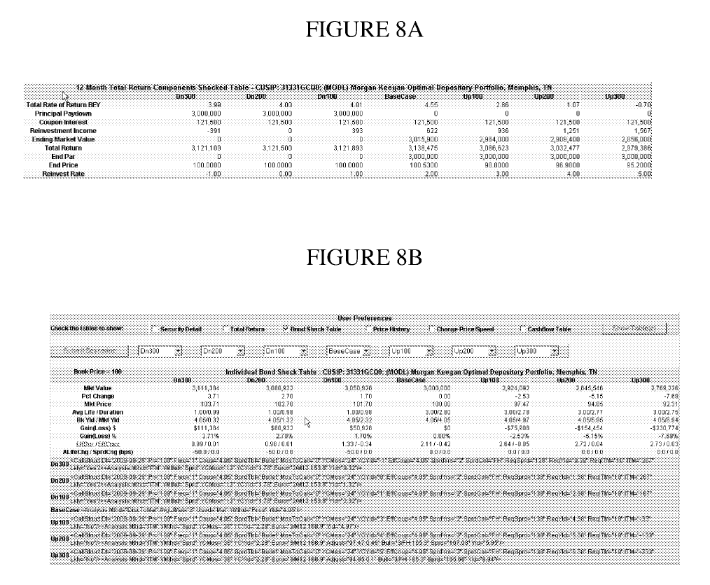

The portfolio analytics program may provide online inventories with dynamic market value shocks and cashflows, as shown exemplarily in FIGS. 8A and 8B. FIG. 8A shows a basic scenario analysis using total return methodology, and FIG. 8B shows a basic scenario analysis of value, yield and call option exercise probability The portfolio analytics program may contain search and sort capabilities, including multiple sort and select capabilities. The portfolio analytics program may provide custom reporting that allows for the creation and downloading of data and reports, e.g., into Excel from the browser. The portfolio analytics program may receive accounting information from an accounting program and may automatically upload the accounting information to the web as the information is calculated at the end of the month.

The portfolio analytics program may include a trade simulation that allows the user to: view and sort securities shocked +/−300 by prior to either buying or selling as shown exemplarily in FIGS. 8A and 8B; view detailed transaction analysis including buy versus sell (average lives, durations and yields), increase/decrease in monthly income, and breakeven analysis; and analyze the impact to total portfolio, market value shocks, and cashflows before and after transaction +/−300 bp. The portfolio analytics program may provide online, downloadable call analysis. The portfolio analytics program may provide the ability to load a new portfolio, add/delete securities from an existing portfolio, update prices and recalculate analytics, market value shocks and cashflows.

The portfolio analytics program may provide interaction with a portfolio online, run what-if scenarios, shock a portfolio using interest rate assumptions and more. Investors can access the portfolio analytics program at any time from any computer—providing constant access to portfolios and research. The portfolio analytics program may provide multiple reports, including: View Inventories, View Cashflows, Shock Portfolios, Simulate Trades, Run What-if Scenarios, Create Customized Reports. Fundamental data is delivered on an “as reported” and standardized basis. Estimates are delivered in real-time, while other financial data is delivered as soon as it enters the market.

The portfolio analytics program may provide monthly rates of return on portfolios and composites, calculated using the internal rate of return method, trade date accounting, full interest and dividend accrual, and daily cash flows. The portfolio analytics program may provide daily rates of return based on current market values and using fully valued daily accounting procedures to reflect capital gains or losses as well as interest or dividend income. The portfolio analytics program may provide dollar-weighted monthly returns linked to provide time-weighted rates for periods longer than one month.

The portfolio analytics program may provide a domestic equity report analyzing the incremental return differences between the portfolio and a benchmark in terms of weighting and selection within a single exposure factor. The report may also include detailed information on asset mix, portfolio characteristics, risk, impact of turnover and security level high/low sorts by performance, market value, market capitalization, dividend yield, beta and P/E ratio. The report may incorporate the holdings of pooled domestic vehicles into the analysis.

The portfolio analytics program may provide a fixed income report that includes information on asset mix, variance analysis and portfolio characteristics including security type, maturity, duration, coupon and quality. The variance analysis report presents the incremental return differences between the portfolio and a benchmark in terms of weighting and selection within a single exposure factor.

The portfolio analytics program may provide a report that includes foreign equity base and local returns relative to a benchmark and attributes the difference to four factors: country weighting, security selection, currency effect and hedging activity.

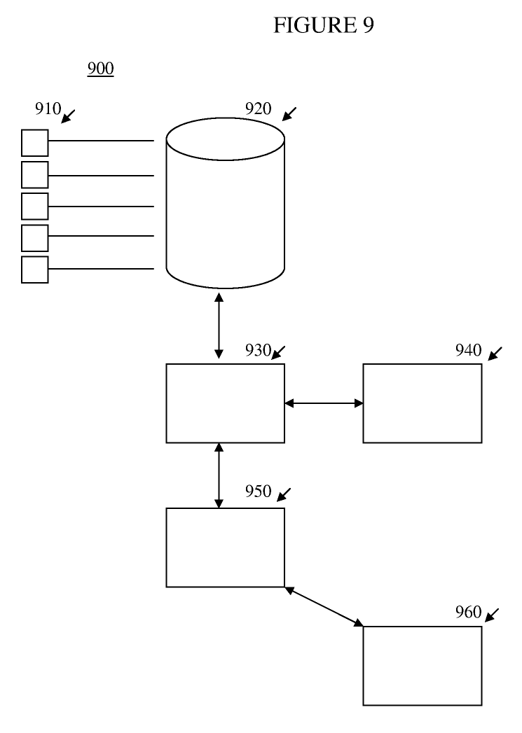

Referring to the Figures by characters of reference, FIG. 9 depicts a system diagram. Portfolio analytics system 900 processes information feeds, such as, for example, financial feeds from Bloomberg. Portfolio analytics system 900 includes a database 920, an analytics server 930, and an accounting server 940. Portfolio analytics system 900 further includes a web server 950 and a website 960. The database 920 receives information from the feeds 910.

As described generally above, the database 920 receives information from various financial information sources 910, including, e.g., Bloomberg, Thomson, Reuters, etc. This information updates various securities information including call dates, if called, etc.

The analytics server 930 communicates with the database 920, and, upon request, provides real-time reports. The reports may be adjustable and interactive. The analytics server 930 is also in communication with the accounting server 940 that maintains an extensive separate database (not shown) of portfolios and securities information.

The web server 950 provides a website 960, including security and encryption services. Using the website 960, a user can access the database information 920 through the analytics server 930 and the web server 950. The user can receive real-time reports on the website 960.

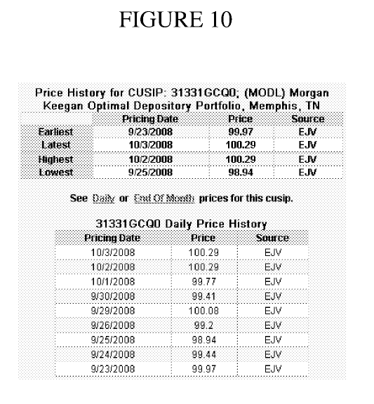

FIG. 10 illustrates a user interface 960 for displaying a report from the database 920. As shown in FIG. 10, information regarding the market price history is displayed.

The accounting server 940 may use third-party software integrated with separate database and a propriety interface for an external pricing source. The accounting server 940 may also use a data feed that allows prices to be imported from a spreadsheet.

The accounting server 940 prices are presented as month-end closing prices even though the pricing process usually begins on or before the 25th of the month in order for reports to be on client's desks in time to make closing entries the day before the end of the month. Thus, an end-of-month (EOM) closing price in the accounting server 940 may actually be the closing price from the 24th of the month. Special follow-up pricing is available early in the following month for most securities for clients that wish to restate EOM prices.

The analytics server 930 was developed in-house with full control of the processes. The analytics server 930 portfolios may be updated and re-priced at anytime using a pricing as-of-date selected by the user. The analytics server 930 uses the latest price available up to, but not exceeding the as-of-date. The analytics server 930 users are also allowed to input their own prices.

The same security may be priced by multiple sources. Not all sources price every security, every day. This leads to a somewhat disorderly collection of security, prices, sources, and dates.

In comparison, the pricing process in the accounting server 940 is more extensive than the analytics server 930. The accounting server 940 process uses more sources, and involves much more human involvement in selecting the most appropriate source for each type of bond. The accounting server 940 prices may be generally considered to be more accurate. Because the two systems were independent, the analytics server 930 was not benefiting from the more extensive pricing process for the accounting server 940.

Therefore, to take advantage of the more extensive pricing process in the accounting server 940 while maintaining the pricing flexibility of the analytics server 930, and to prevent undisclosed conflicts between the two systems, the analytics server 930 pricing interface is designed to incorporate the pricing sources and methods used by the accounting server 940, while eliminating duplication.

The analytics server 930 is designed to use a pricing algorithm that assigns prices to both systems according to a source/date hierarchy that selects the most reliable source for each type of security within a defined, acceptable date range that includes source and date output, preventing two different prices from being published with the same pricing date.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer may have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs may be installed on the internal or external storage of the general-purpose computer. Alternatively, in another implementation, application programs may be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer may include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices may themselves include the functionality of the general-purpose computer. For example, the mobile phone or the PDA may include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link may include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software may be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client may then cause the server containing a computer program to launch an application to, for example, perform an analysis according to the described techniques. In another implementation, the server may download an application to be run on the client to perform an analysis according to the described techniques.

Although the systems and methods have been described in detail, it will be apparent to those of skill in the art that the systems and methods can be embodied in a variety of specific forms and that various changes, substitutions, and alterations can be made without departing from the spirit and scope of the systems and methods described herein. The described embodiments are only illustrative and not restrictive and the scope of the systems and methods is, therefore, indicated by the following claims. Other embodiments are within the scope of the following claims.

What is claimed is:

1. A method of pricing a security, comprising:
creating a hierarchy for a price of a security in an analytics system based upon reliability;
creating a hierarchy for a price of a security in an accounting system based upon reliability; and
selecting a most reliable price between the price in the analytics system and the price in the accounting system.

2. The method of claim 1, further comprising:
assigning the price of the security in the analytics system and the price of the security in the accounting system to be the selected price.

3. The method of claim 2, wherein the step of assigning prevents two different prices from being published with the same pricing date.

4. The method of claim 2, further comprising:
displaying the selected price to a user upon request.

5. The method of claim 1, further comprising:
generating an interactive report from the analytics system for a user upon request.

6. The method of claim 1, further comprising:
researching the security using the analytics system.

7. The method of claim 1, further comprising:
shocking the security using the analytics system.

8. The method of claim 1, wherein the reliability is determined within a date range.

9. The method of claim 1, wherein the reliability is determined according to the source of the price.

10. The method of claim 1, wherein the analytics system receives price information from a first set of sources, and the accounting system receives price information from a second set of sources.

11. The method of claim 10, wherein the first set of sources is the same as the second set of sources; the first set of sources is larger than the second set of sources; or the first set of sources is smaller than the second set of sources.

12. A portfolio pricing system comprising:
a database receiving at least one feed;
an analytics server in communication with the database; and
an accounting server;
wherein the analytics server includes a pricing algorithm that assigns prices to the analytics server and the accounting server according to a hierarchy that selects the most reliable source for each type of security.

13. The system of claim 12, wherein the reliability is determined within a date range.

14. The system of claim 12, wherein the reliability is determined according to the source of the price.

15. The system of claim 12, wherein the analytics server receives price information from a first set of feeds, and the accounting server receives price information from a second set of feeds.

16. The system of claim 12, wherein the first set of feeds is the same as the second set of feeds; the first set of feeds is larger than the second set of feeds; or the first set of feeds is smaller than the second set of feeds.

17. The system of claim 12, further comprising:
a web server, in communication with the analytics server, the web server providing a website to request and display a report for a user.

18. The system of claim 17, wherein the report is at least one of interactive, sortable, customized, pre-formatted, encrypted, real-time, or presented in a spreadsheet.

19. The system of claim 12, wherein the analytics server is configured for portfolio attribution.

20. The system of claim 12, wherein the analytics server is configured for at least one of portfolio measurement, risk management, quantitative analysis, to shock a portfolio, or for detailed analytics.

21. The system of claim 20, wherein the detailed analytics includes cashflows for a total portfolio.

22. The system of claim 20, wherein the detailed analytics includes cashflows for a sector of a total portfolio.

23. The system of claim 20, wherein the detailed analytics includes cashflows for an individual bond.

24. The system of claim 12, wherein the analytics server is configured for trade simulation.

25. The system of claim 12, wherein the analytics server is configured for at least one of a monthly rate of return on a total portfolio, a daily rate of return on a total portfolio, a time-weighted rate of return on a total portfolio, or researching the security using the database.

26. A computer-readable medium having computer-executable instructions for pricing a security, the computer-readable medium comprising:
computer-executable instructions for creating a hierarchy for a price of a security in an analytics system based upon reliability;
computer-executable instructions for creating a hierarchy for a price of a security in an accounting system based upon reliability;
computer-executable instructions for selecting a most reliable price between the price in the analytics system and the price in the accounting system.

27. The computer-readable medium of claim 26, further comprising:
computer-executable instructions for assigning the price of the security in the analytics system and the price of the security in the accounting system to be the selected price.

28. The computer-readable medium of claim 26, further comprising:
computer-executable instructions for displaying the selected price to a user upon request.

29. The computer-readable medium of claim 26, further comprising:
computer-executable instructions for generating an interactive report from the analytics system for a user upon request.

30. The computer-readable medium of claim 26, further comprising:
computer-executable instructions for researching the security using the analytics system.

31. The computer-readable medium of claim 26, further comprising:
computer-executable instructions for shocking the security using the analytics system.

32. The computer-readable medium of claim 26, wherein the reliability is determined within a date range.

33. The computer-readable medium of claim 26, wherein the reliability is determined according to the source of the price.

34. The computer-readable medium of claim 26, wherein the analytics system receives price information from a first set of sources, and the accounting system receives price information from a second set of sources.

35. The computer-readable medium of claim 26, wherein the first set of sources is the same as the second set of sources; the first set of sources is larger than the second set of sources; or the first set of sources is smaller than the second set of sources.
